(19) United States
(12) Patent Application Publication
(10) Pub. No.: US 2017/0136730 A1
(43) Pub. Date: May 18, 2017

(54) Wrap Mat

(71) Applicant: Milliken & Company, Spartanburg, SC (US)

(72) Inventors: Ty G. Dawson, Spartanburg, SC (US); Franklin S. Love, III, Columbus, NC (US); Venkatkrishna Raghavendran, Houston, TX (US); Brandon T. Roberts, Greer, SC (US); Padmakumar Puthillath, Greer, SC (US); Dale S. Kitchen, Boiling Springs, SC (US); Gordon J. Stannis, Saugatuck, MI (US); Brent A. Beukema, Grand Rapids, MI (US)

(73) Assignee: Milliken & Company, Spartanburg, SC (US)

(21) Appl. No.: 15/343,274

(22) Filed: Nov. 4, 2016

Related U.S. Application Data
(60) Provisional application No. 62/256,730, filed on Nov. 18, 2015.

(51) Int. Cl. B32B 5/02; A47L 23/26

(52) U.S. Cl. CPC B32B 5/022; B32B 5/024; B32B 5/026; A47L 23/266; B32B 2471/04; B32B 2471/02

(57) ABSTRACT

This invention relates to a floor mat and frame. The floor mat is comprised of a flexible, textile component that attaches to a frame component by wrapping the textile component over and around the edges of the frame component. The textile component is designed to be soiled, washed, and re-used, thereby providing ideal end-use applications in areas such as building entryways.

### CROSS REFERENCE TO RELATED APPLICATIONS

This application claims priority to U.S. Provisional Patent Application Number 62/256,730, entitled “Wrap Mat” which was filed on Nov. 18, 2015, and which is entirely incorporated by reference herein.

### TECHNICAL FIELD

This invention relates to a floor mat and frame. The floor mat is comprised of a flexible, textile component that attaches to a frame component by wrapping the textile component over and around the edges of the frame component. The textile component is designed to be soiled, washed, and re-used, thereby providing ideal end-use applications in areas such as building entryways.

### BACKGROUND

High traffic areas, such as entrances to buildings, restrooms, break areas, etc., typically have the highest floorcovering soiling issue. Currently, washable one-piece mats having a pile surface and a heavy, rubber backing material are found in these locations. The washable floor mat of the present invention is designed to replace these one-piece floor mats.

The use of washable floor mats in high traffic, highly soiled areas is pragmatic because the soiled textile component may be easily removed, laundered, and re-installed. The need to launder the heavy, rubber backing portion of the floor mat is eliminated. The reduction in weight and bulk from one-piece mats to the textile component of the multi-component floor mat described herein provides significant savings in water and energy for the laundering facilities and in labor for the service people that transport and install the floor mats. Thus, the washable wrap mat of the present invention is an improvement over one-piece floor mats of the prior art.

### BRIEF SUMMARY

In one aspect, the invention relates to a wrap mat comprising a textile component and a frame component, wherein the frame component is comprised of materials selected from the group consisting of at least one polymer selected from the group consisting of thermoplastic elastomers and thermoset elastomers, a metal material, a cellulose-containing material, and combinations thereof, and wherein the textile component is wrapped over and at least partially around the frame component.

In another aspect, the invention relates to a wrap mat comprising a textile component; a frame component, wherein the frame component is comprised of materials selected from the group consisting of at least one polymer selected from the group consisting of thermoplastic elastomers and thermoset elastomers, a metal material, a cellulose-containing material, and combinations thereof; and an absorbent component; wherein the textile component is wrapped over and at least partially around the frame component.

In a further aspect, the invention relates to a flooring system comprised of at least two wrap mats, wherein the wrap mat is comprised of a textile component, and a frame component, wherein the frame component is comprised of materials selected from the group consisting of at least one polymer selected from the group consisting of thermoplastic elastomers and thermoset elastomers, a metal material, a cellulose-containing material, and combinations thereof, and wherein the textile component is wrapped over and at least partially around the frame component.

### BRIEF DESCRIPTION OF THE DRAWINGS

FIG. 1 is a schematic diagram of one embodiment of the wrap mat of the present invention with a portion of the textile component pulled back.

FIG. 2A is an expanded side view of the components comprising the wrap mat in an unassembled arrangement.

FIG. 2B is an expanded side view of the components comprising the wrap mat in an assembled arrangement.

FIG. 2C is an expanded, partial side view of the wrap mat of FIG. 2B.

FIG. 3A is a schematic diagram of another embodiment of the wrap mat of the present invention with a portion of the textile component pulled back.

FIG. 3B is a schematic diagram illustrating multiple wrap mats of the present invention installed in a side-by-side arrangement and with a portion of the textile component pulled back.

### DETAILED DESCRIPTION

The present invention described herein is a wrap mat comprised of: (a) a washable and flexible textile component and (b) a frame component. The textile component is attached to the frame component by manual stretching of the textile component over and/or around the frame component. The textile component is designed for easy removal from the frame component for laundering in a residential and/or commercial laundry facility.

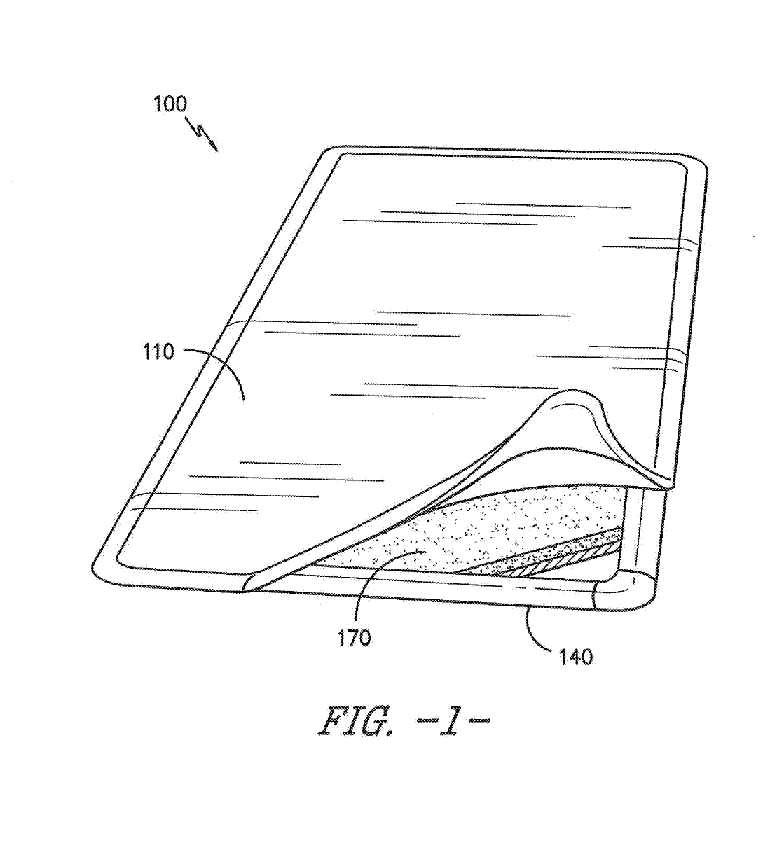

As illustrated in FIG. 1, the present invention describes a wrap mat 100 comprised of a textile component 110 and a frame component 140. The wrap mat 100 may further include at least one absorbent component 170. The textile component 110 wraps over and covers frame component 140 and absorbent component 170.

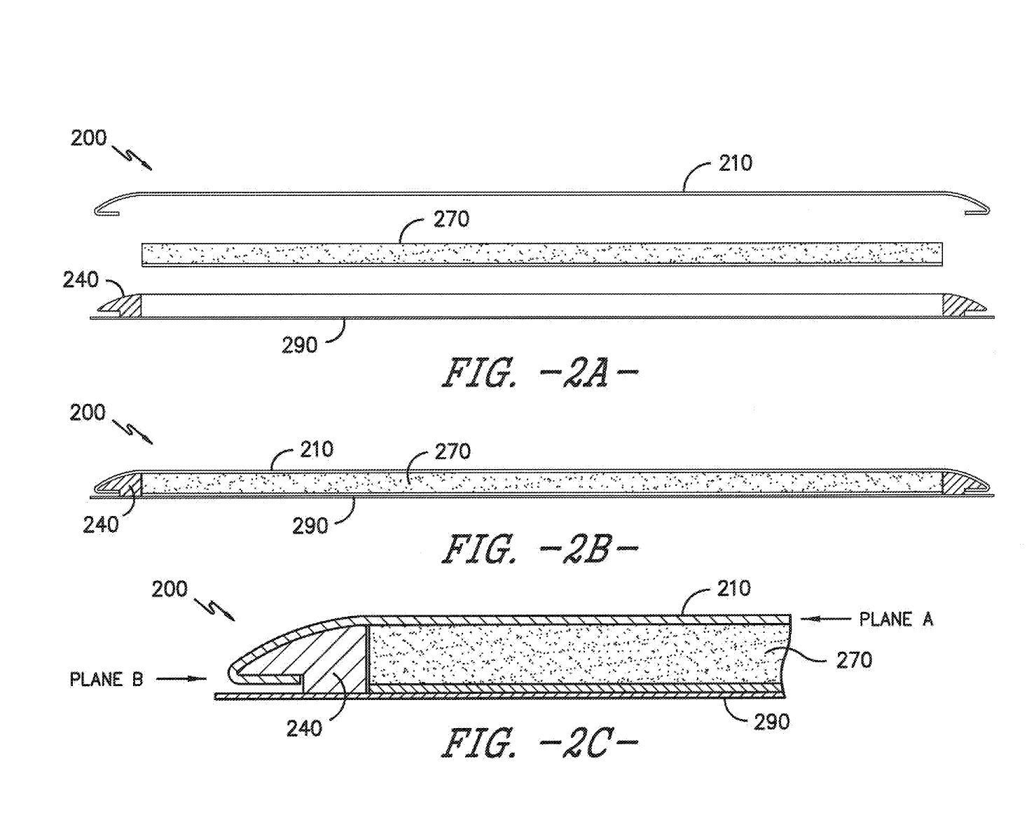

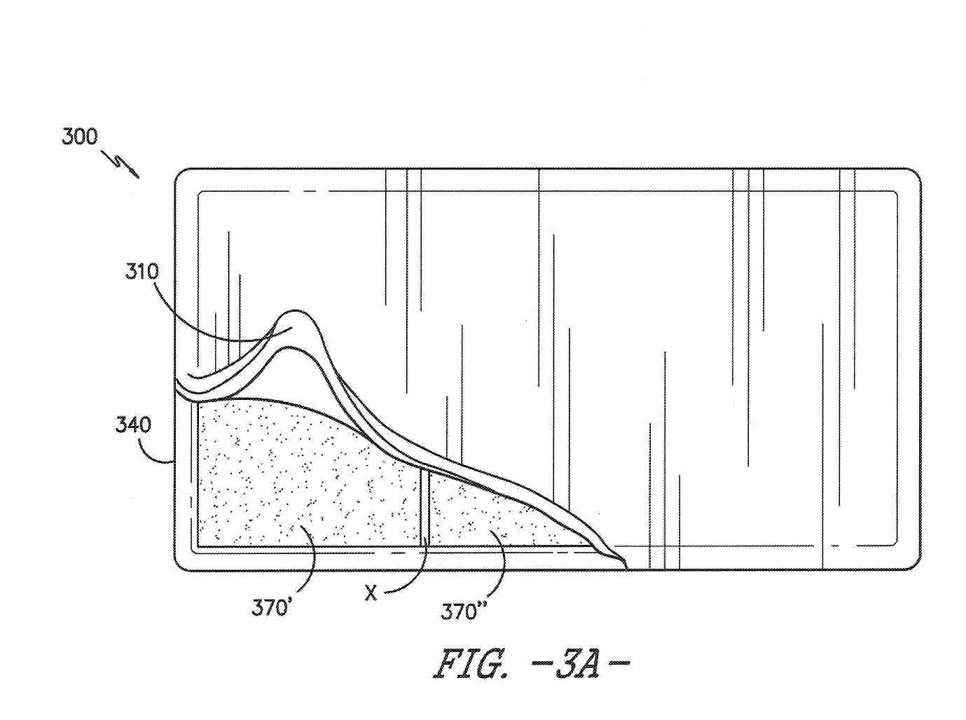

FIG. 2A illustrates the unassembled arrangement of the components comprising wrap mat 200. The frame component 240 lies primarily in a planar configuration with floor surface 290 (or other wrap mat-receiving area). The next layer is the optional absorbent component 270. Finally, textile component 210 is the uppermost layer of wrap mat 200.

FIG. 2B illustrates the assembled arrangement of the components of wrap mat 200. Frame component 240 receives absorbent component 270 within its perimeter. Absorbent component 270 is aligned substantially parallel with and immediately adjacent to floor surface 290. Textile component 210 is aligned substantially parallel with and immediately adjacent to absorbent component 270. Textile component 210 covers and at least partially encapsulates absorbent component 270 and frame component 240. In one aspect, frame component 240 is completely hidden from view in its end-use application by textile component 210. Of course, if one were to place wrap mat 200 onto its back (wherein textile component 210 is now contacting floor surface 290; a 180 degree change in placement), then one would see at least part of frame component 240.

FIG. 2C shows a portion of wrap mat 200 wherein textile component 210 wraps around frame component 240. In wrapping around frame component 240, a portion of textile component 210 leaves geometric Plane A and enters geometric Plane B of frame component 240. Thus, in one aspect, at least a portion of the textile component of the wrap mat is in a planar relationship with itself and with the frame component. The resulting wrap mat 200 spatially encases at least a portion of absorbent component 270 within frame component 240, textile component 210, and floor surface 290.

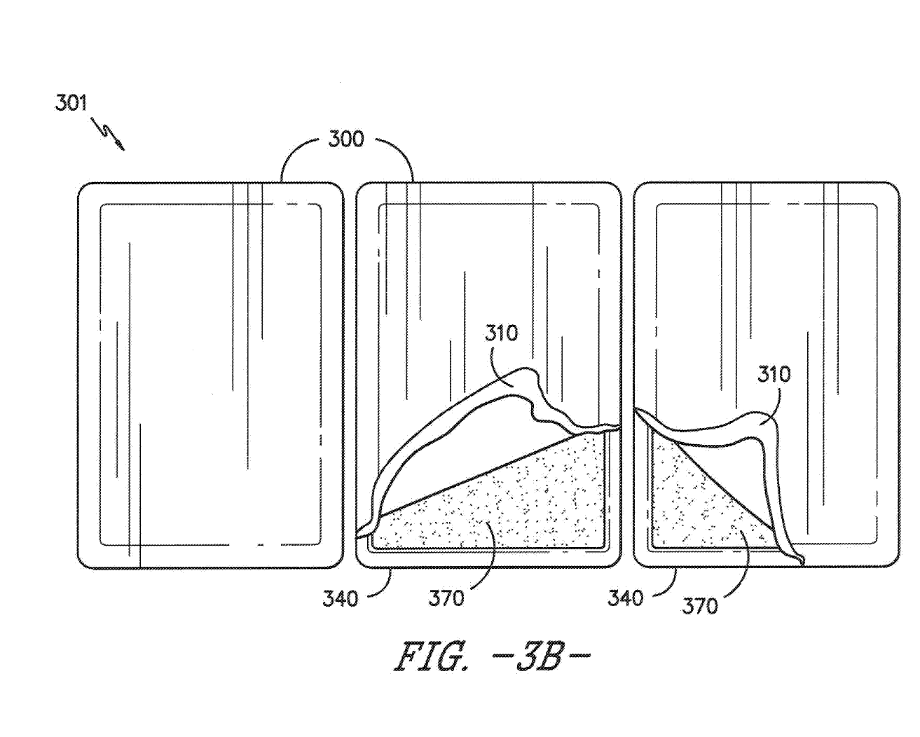

FIG. 3A illustrates wrap mat 300 wherein the absorbent component is comprised of more than one piece of absorbent material. As is evident from the pulled back area of wrap mat 300, a dividing line X is present which indicates where one absorbent component 370′ ends and a second absorbent component 370″ begins. This arrangement allows for instances when only a portion of the absorbent component needs be removed and/or replaced from the wrap mat, as opposed to instances when the entire absorbent component is removed/replaced at one time. Textile component 310 covers absorbent component 370′ and 370″ and wraps over frame component 340. As shown in FIG. 3B, more than one wrap mat 300 may be combined together in a side-by-side arrangement to form a wrap mat flooring system 301. As described previously, wrap mat 300 is comprised of frame component 340, textile component 310 and optionally, absorbent component 370.

The textile component of the wrap mat may be comprised of tufted pile carpet. Tufted pile carpet is comprised of a primary backing layer and face yarns. The primary backing layer is typically included in the tufted pile carpet to give stability to the face yarns. The materials comprising the face yarns and the primary backing layer may independently be selected from synthetic fiber, natural fiber, man-made fiber using natural constituents, inorganic fiber, glass fiber, and a blend of any of the foregoing. By way of example only, synthetic fibers may include polyester, acrylic, polyamide, polyolefin, polyaramid, polyurethane, or blends thereof. More specifically, polyester may include polyethylene terephthalate, polytrimethylene terephthalate, polybutylene terephthalate, polylactic acid, or combinations thereof.

Polyamide may include nylon 6, nylon 6,6, or combinations thereof. Polyolefin may include polypropylene, polyethylene, or combinations thereof. Polyaramid may include poly-p-phenyleneteraphthalamide (i.e., Kevlar®), poly-m-phenyleneteraphthalamide (i.e., Nomex®), or combinations thereof. Exemplary natural fibers include wool, cotton, linen, ramie, jute, flax, silk, hemp, or blends thereof. Exemplary man-made materials using natural constituents include regenerated cellulose (i.e., rayon), lyocell, or blends thereof.

The material comprising the face yarns and primary backing layer may be formed from staple fiber, filament fiber, slit film fiber, or combinations thereof. The fiber may be exposed to one or more texturing processes. The fiber may then be spun or otherwise combined into yarns, for example, by ring spinning, open-end spinning, air jet spinning, vortex spinning, or combinations thereof. Accordingly, the material comprising the face yarns will generally be comprised of interlaced fibers, interlaced yarns, loops, or combinations thereof.

The material comprising the face yarns and primary backing layer may be comprised of fibers or yarns of any size, including microdenier fibers or yarns (fibers or yarns having less than one denier per filament). The fibers or yarns may have deniers that range from less than about 0.1 denier per filament to about 2000 denier per filament or, more preferably, from less than about 1 denier per filament to about 500 denier per filament.

Furthermore, the material comprising the face yarns and primary backing layer may be partially or wholly comprised of multi-component or bi-component fibers or yarns in various configurations such as, for example, islands-in-the-sea, core and sheath, side-by-side, or pie configurations. Depending on the configuration of the bi-component or multi-component fibers or yarns, the fibers or yarns may be splittable along their length by chemical or mechanical action.

Additionally, the face yarns and the primary backing layer may include additives coextruded therein, may be precoated with any number of different materials, including those listed in greater detail below, and/or may be dyed or colored to provide other aesthetic features for the end user with any type of colorant, such as, for example, poly(oxyalkylenated) colorants, as well as pigments, dyes, tints, and the like. Other additives may also be present on and/or within the target fiber or yarn, including antistatic agents, brightening compounds, nucleating agents, antioxidants, UV stabilizers, fillers, permanent press finishes, softeners, lubricants, curing accelerators, and the like.

The face yarns may be dyed or undyed. If the face yarns are dyed, they may be solution dyed. The weight of the face yarn, pile height, and density will vary depending on the desired aesthetics and performance requirements of the end-use for the floor mat. The face yarns constructions include loop pile, cut pile, and combinations of loop pile and cut pile.

The primary backing layer can be any suitable primary backing material. The primary backing layer may be comprised of a woven, nonwoven or knitted material, or combinations thereof. The general purpose of the primary backing layer is to support the tufts of the face yarns. In one aspect, the primary backing layer is a nonwoven polyester spunbond material. One commercially available example of the polyester spunbond material is Lutradur® from Freudenberg Nonwovens of Weinheim, Germany. In another aspect, flat woven polyester tapes, such as Isis™ from Propex of Chattanooga, Ten., may be utilized. Also, Colback® nonwoven backing material may also be suitable for use. If needed, a primary backing layer made of a woven tape with either staple fibers or nonwoven fabrics affixed can be used. Also, stitch bonded and knitted polyester fabrics may be used.

The tufted pile carpet that includes face yarns tufted into a primary backing layer may be heat stabilized to prevent dimensional changes from occurring in the finished mat. The heat stabilizing or heat setting process typically involves applying heat to the material that is above the glass transition temperature, but below the melting temperature of the components. The heat allows the polymer components to release internal tensions and allows improvement in the internal structural order of the polymer chains. The heat stabilizing process can be carried out under tension or in a relaxed state. The tufted pile carpet is sometimes also stabilized to allow for the yarn and primary backing to shrink prior to the mat manufacturing process.

Examples of suitable compositions for forming the second layer (i.e. the layer having direct contact with the frame component) of the textile component include at least one polymer selected from the group consisting of thermoplastic and thermoset elastomers. Thermoplastic elastomers include thermoplastic vulcanizate, styrenic block co-polymer, thermoplastic polyurethanes, thermoplastic copolyesters, thermoplastic copolyamides, polyolefinic blends and mixtures thereof. Thermoset elastomers include natural rubber, synthetic rubber, and mixtures thereof.

Thermoset elastomers include nitrile rubber (including dense nitrile rubber and foam nitrile rubber), polyvinyl chloride rubber, ethylene propylene diene monomer (EPDM) rubber, vinyl rubber, and mixtures thereof. In one aspect, the backing layer of the textile component is typically comprised of at least one rubber material. The rubber material may contain from 0% to 40% of a recycled rubber material.

In one aspect of the present invention, the tufted pile carpet is comprised of yarn tufted into fabric, which is then injection or fluid dyed, and then bonded with a rubber layer or washable latex backing. The carpet yarn may be selected from nylon 6; nylon 6,6; polyester; and polypropylene fiber. The yarn is tufted into a woven or nonwoven substrate. The yarn can be of any pile height and weight necessary to support printing. The tufted pile carpet may be printed using any print process. In one aspect, injection dyeing may be utilized to print the tufted pile carpet.

Printing inks will contain at least one dye. Dyes may be selected from acid dyes, direct dyes, reactive dyes, cationic dyes, disperse dyes, and mixtures thereof. Acid dyes include azo, anthraquinone, triphenyl methane and xanthine types. Direct dyes include azo, stilbene, thiazole, dioxsazine and phthalocyanine types. Reactive dyes include azo, anthraquinone and phthalocyanine types. Cationic dyes include thiazole, methane, cyanine, quinolone, xanthene, azine, and triaryl methine. Disperse dyes include azo, anthraquinone, nitrodiphenylamine, naphthal imide, naphthoquinone imide and methane, triarylmethine and quinoline types.

As is known in the textile printing art, specific dye selection depends upon the type of fiber and/or fibers comprising the washable textile component that is being printed. For example, in general, a disperse dye may be used to print polyester fibers. Alternatively, for materials made from cationic dyeable polyester fiber, cationic dyes may be used.

The printing process of the present invention uses a jet dyeing machine, or a digital printing machine, to place printing ink on the surface of the mat in predetermined locations. One suitable and commercially available digital printing machine is the Millitron® digital printing machine, available from Milliken & Company of Spartanburg, South Carolina. The Millitron® machine uses an array of jets with continuous streams of dye liquor that can be deflected by a controlled air jet. The array of jets, or gun bars, is typically stationary. Another suitable and commercially available digital printing machine is the Chromojet® carpet printing machine, available from Zimmer Machinery Corporation of Spartanburg, S.C. In one aspect, a tufted carpet made according to the processes disclosed in U.S. Pat. No. 7,678,159 and U.S. Pat. No. 7,846,214, both to Weiner, may be printed with a jet dyeing apparatus as described and exemplified herein.

Viscosity modifiers may be included in the printing ink compositions. Suitable viscosity modifiers that may be utilized include known natural water-soluble polymers such as polysaccharides, such as starch substances derived from corn and wheat, gum arabic, locust bean gum, tragacanth gum, guar gum, guar flour, polygalactomannan gum, xanthan, alginates, and a tamarind seed; protein substances such as gelatin and casein; tannin substances; and lignin substances. Examples of the water-soluble polymer further include synthetic polymers such as known polyvinyl alcohol compounds and polyethylene oxide compounds. Mixtures of the aforementioned viscosity modifiers may also be used. The polymer viscosity is measured at elevated temperatures when the polymer is in the molten state. For example, viscosity may be measured in units of centipoise at elevated temperatures, using a Brookfield Thermosel unit from Brookfield Engineering Laboratories of Middleboro, MA. Alternatively, polymer viscosity may be measured by using a parallel plate rheometer, such as made by Haake from Rheology Services of Victoria Australia.

After printing, the tufted pile carpet may be vulcanized with a rubber backing. Once vulcanized, the textile component may be pre-shrunk by washing. The resulting textile component is wash durable and exhibits sufficient tuft lock for normal end-use applications. In one alternative embodiment of the invention, the textile component may be a disposable textile component that is removed and disposed of or recycled and then replaced with a new textile component for attachment to the frame component.

While the textile component of the wrap mat has been described as being comprised of tufted pile carpet, it is contemplated to be within the scope of the present invention that the textile component may be comprised of other materials.

For example, the textile component may be comprised of tufted pile carpet, loop pile carpet, a nonwoven substrate, a woven substrate, a knit substrate, and the like, and combinations thereof. The material comprising any of these textile components are selected from those as described above with respect to the tufted pile carpet and include fiber and/or yarn type, construction, and finishing and/or printing features.

The frame component is sized to accommodate the textile component. The frame component of the wrap mat may be comprised of any material that exhibits sufficient strength such that when the textile component is wrapped around it, there is no deformation of the wrap mat. As such, the material comprising the frame component should be dimensionally stable and capable of being laid flat or otherwise having the ability to conform to the floor surface. Examples of suitable materials for forming the frame component include at least one polymer selected from the group consisting of thermoplastic elastomers and thermoset elastomers, a metal material, a cellulose-containing material, and combinations thereof.

The frame component of the wrap mat may be partially or wholly covered with the textile component. The textile component is releasably attached to the frame component. Typically, the textile component will be lighter in weight than the frame component. Inversely, the frame component will weigh more than the textile component. In one aspect, the textile component is seamless (i.e. contains no seams).

The frame component may also include a border, whereby the border provides greater dimensional stability to the frame component, for example, because the border is thicker, i.e. greater in height relative to the floor surface. Additionally, the border may be angled upward from its outer perimeter towards the interior of the frame component. The gradual incline from the outer perimeter of the border to the inner perimeter of the border may minimize tripping hazards.

The frame component, including the border, may be formed in a single molding process as a unitary article, or it may be a modular (comprised of more than one piece) article. The frame component typically contains a recessed area surrounded by a border. The recessed area of the frame component possesses a certain amount of depth, thereby defining it as “recessed.” In one aspect, the absorbent component is shaped to fit within the border of the frame component.

The absorbent component of the wrap mat may be comprised of any material that is designed to absorb liquid. For example, the absorbent component may be comprised of foam materials (such as polyurethane foam), fibrous materials (such as woven, knitted or nonwoven materials), molded materials (such as three-dimensional materials with cavities to hold liquid), and mixtures thereof.

Wrap mats of the present invention may be of any geometric shape or size, as desired for its end-use application. The longitudinal edges of the floor mats may be of the same length and width, thus forming a square shape. Or, the longitudinal edges of the floor mats may have different dimensions such that the width and the length are not the same. Alternatively, the floor mats may be rectangular, circular, hexagonal, and the like. As one non-limiting example, floor mats of the present invention may be manufactured into any of the current industry standards sizes that include 2 feet by 4 feet, 3 feet by 4 feet, 3 feet by 5 feet, 4 feet by 6 feet, 3 feet by 10 feet, and the like. In addition, any number of wrap mats may be combined to form a wrap mat flooring system of the present invention.

The washable wrap mat of the present invention may be exposed to post-treatment steps. For example, chemical treatments such as stain release, stain block, antimicrobial resistance, bleach resistance, and the like, may be added to the wrap mat, and more specifically, to the textile component of the wrap mat.

Mechanical post-treatments may include cutting, shearing, and/or napping the surface of the textile component of the wrap mat.

The performance requirements for commercial matting include a mixture of well documented standards and industry known tests. Tuft Bind of Pile Yarn Floor Coverings (ASTM D1335) is one such performance test referenced by several organizations (e.g. General Services Administration). Achieving tuft bind values greater than 4 pounds is desirable, and greater than 5 pounds even more desirable.

Resistance to Delamination of the Secondary Backing of Pile Yarn Floor Covering (ASTM D3936) is another standard test. Achieving Resistance to Delamination values greater than 2 pounds is desirable, and greater than 2.5 pounds even more desirable.

Pilling and fuzzing resistance for loop pile (ITTS112) is a performance test known to the industry and those practiced in the art. The pilling and fuzzing resistance test is typically a predictor of how quickly the carpet will pill, fuzz and prematurely age over time. The test uses a small roller covered with the hook part of a hook and loop fastener. The hook material is Hook 88 from Velcro of Manchester, NH and the roller weight is 2 pounds. The hook-covered wheel is rolled back and forth on the tufted carpet face with no additional pressure. The carpet is graded against a scale of 1 to 5. A rating of 5 represents no change or new carpet appearance. A rating of less than 3 typically represents unacceptable wear performance.

An additional performance/wear test includes the Hexapod drum tester (ASTM D-5252 or ISO/TR 10361 Hexapod Tumbler). This test is meant to simulate repeated foot traffic over time. It has been correlated that a 12,000 cycle count is equivalent to ten years of normal use. The test is rated on a gray scale of 1 to 5, with a rating after 12,000 cycles of 2.5=moderate, 3.0=heavy, and 3.5=severe. Yet another performance/wear test includes the Radiant Panel Test. Some commercial tiles struggle to achieve a Class I rating, as measured by ASTM E 648-06 (average critical radiant flux >0.45=class I highest rating).

The textile component of the wrap mat may be washed or laundered in an industrial, commercial or residential washing machine. In one aspect, the textile component of the wrap mat withstands at least one wash cycle in a commercial or residential washing machine whereby the textile component is suitable for re-use after exposure to the at least one wash cycle. Achieving 200 commercial washes of the textile component with no structural failure is preferred.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the subject matter of this application (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the subject matter of the application and does not pose a limitation on the scope of the subject matter unless otherwise claimed. No language in the specification should be construed as indicating any non-claimed element as essential to the practice of the subject matter described herein.

Preferred embodiments of the subject matter of this application are described herein, including the best mode known to the inventors for carrying out the claimed subject matter. Variations of those preferred embodiments may become apparent to those of ordinary skill in the art upon reading the foregoing description. The inventors expect skilled artisans to employ such variations as appropriate, and the inventors intend for the subject matter described herein to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the present disclosure unless otherwise indicated herein or otherwise clearly contradicted by context.

We claim:

1. A wrap mat comprising:
(a) a textile component, and
(b) a frame component comprised of materials selected from the group consisting of at least one polymer selected from the group consisting of thermoplastic elastomers and thermoset elastomers, a metal material, a cellulose-containing material, and combinations thereof, and
wherein the textile component is wrapped over and at least partially around the frame component.

2. The wrap mat of claim 1, wherein the floor mat further includes at least one absorbent component.

3. The wrap mat of claim 2, wherein the frame component contains a recessed area and the at least one absorbent component is located in the recessed area of the frame component.

4. The wrap mat of claim 1, wherein the frame component is a single, unitary article.

5. The wrap mat of claim 1, wherein the frame component is a modular article.

6. The wrap mat of claim 1, wherein a portion of the textile component is present in a planar relationship with itself and with the frame component.

7. The wrap mat of claim 1, wherein the textile component is releasably attached to the frame component.

8. The wrap map of claim 1, wherein the textile component withstands at least one wash cycle in a commercial or residential washing machine whereby the textile component is suitable for re-use after exposure to the at least one wash cycle.

9. The wrap mat of claim 1, wherein the textile component is comprised of tufted pile carpet, loop pile carpet, a nonwoven substrate, a woven substrate, a knit substrate, and combinations thereof.

10. The wrap mat of claim 9, wherein the textile component is comprised of: (i) a first layer of tufted pile carpet formed by tufting face yarns through a primary backing layer and (ii) a second layer comprised of at least one polymer selected from the group consisting of thermoplastic and thermoset elastomers.

11. A wrap mat comprising:
(a) a textile component,
(b) a frame component comprised of materials selected from the group consisting of at least one polymer selected from the group consisting of thermoplastic elastomers and thermoset elastomers, a metal material, a cellulose-containing material, and combinations thereof, and
(c) an absorbent component, and
wherein the textile component is wrapped over and at least partially around the frame component.

12. The wrap mat of claim 11, wherein the frame component contains a recessed area and the at least one absorbent component is located in the recessed area of the frame component.

13. The wrap mat of claim 11, wherein the frame component is a single, unitary article.

14. The wrap mat of claim 11, wherein the frame component is a modular article.

15. The wrap mat of claim 11, wherein a portion of the textile component is present in a planar relationship with itself and with the frame component.

16. The wrap mat of claim 11, wherein the textile component is releasably attached to the frame component.

17. The wrap mat of claim 11, wherein the textile component is comprised of tufted pile carpet, loop pile carpet, a nonwoven substrate, a woven substrate, a knit substrate, and combinations thereof.

18. The wrap mat of claim 17, wherein the textile component is comprised of: (i) a first layer of tufted pile carpet formed by tufting face yarns through a primary backing layer and (ii) a second layer comprised of at least one polymer selected from the group consisting of thermoplastic and thermoset elastomers.

19. A flooring system comprised of at least two wrap mats, wherein the wrap mat is comprised of:
(a) a textile component, and
(b) a frame component comprised of materials selected from the group consisting of at least one polymer selected from the group consisting of thermoplastic elastomers and thermoset elastomers, a metal material, a cellulose-containing material, and combinations thereof, and
wherein the textile component is wrapped over and at least partially around the frame component.

20. The wrap mat of claim 19, wherein the textile component is comprised of tufted pile carpet, loop pile carpet, a nonwoven substrate, a woven substrate, a knit substrate, and combinations thereof.
